(19) United States
(12) Patent Application Publication
(10) Pub. No.: US 2011/0093272 A1
(43) Pub. Date: Apr. 21, 2011

(54) MEDIA PROCESS SERVER APPARATUS AND MEDIA PROCESS METHOD THEREFOR

(75) Inventors: Shin-ichi Isobe, Kanagawa (JP); Masami Yabusaki, Chiba (JP)

(73) Assignee: NTT DOCOMO, INC, TOKYO (JP)

(21) Appl. No.: 12/937,061

(22) PCT Filed: Apr. 2, 2009
(86) PCT No.: PCT/JP2009/056866

§ 371 Date: Dec. 22, 2010

(30) Foreign Application Priority Data
Apr. 8, 2008 (JP) 2008-100453

(51) Int. Cl. G10L 13/02

(52) U.S. Cl. 704/258; 704/E13.002

(57) ABSTRACT

A media process server apparatus has a speech synthesis data storage device for storing, after categorizing into emotions, data for speech synthesis in association with a user identifier, a text analyzer for determining, from a text message received from a message server apparatus, emotion of text, and a speech data synthesizer for generating speech data with emotional expression by synthesizing speech corresponding to the text, using data for speech synthesis that corresponds to the determined emotion and that is in association with a user identifier of a user who is a transmitter of the text message.

### TECHNICAL FIELD

The present invention relates to a media process server apparatus and to a media process method capable of synthesizing speech messages based on text data.

### BACKGROUND ART

Message communication using text, typified by electronic mail, is now widely used thanks to highly developed information processing techniques and communication techniques. In such a message communication using text, graphic emoticons, and text emoticons or face marks created by a combination of plural characters are often used in a message, to express the content of a message in a manner that is richer in emotion.

Conventionally, there is known a terminal apparatus having a function of reading a message contained in electronic mail, with the caller's voice in an emotion-charged manner (refer to, for example, Patent Document 1).

A terminal apparatus described in Patent Document 1 stores, in association with a phone number or a mail address, voice characteristic data obtained from speech data obtained during a voice call after categorizing the data into emotions. Furthermore, upon receiving a message from a correspondent at the other end for whom voice characteristic data is stored, the terminal apparatus determines to which emotion text data contained in the message corresponds, executes speech synthesis by using voice characteristic data corresponding to a mail address, and performs the reading of the message.

Patent document 1: Japanese Patent Publication No. 3806030

### DISCLOSURE OF INVENTION

### Problems to be Solved by the Invention

However, in the above conventional terminal apparatus, due to limitations such as memory capacity, the number of correspondents for whom voice characteristic data can be registered or the number of registered pieces of voice characteristic data per correspondent is limited. Therefore, there is a problem in that there is little variation in emotional expression that can be used for synthesis, and the degree of accuracy in synthesis is degraded.

The present invention has been made in view of the above situations, and has as an object to provide a media process server apparatus capable of synthesizing, from text data, a speech message which is of high quality and for which emotional expressions are rich, and also to provide a media process method therefor.

### Means for Solving the Problems

In order to solve the problem above, the present invention provides a media process server apparatus for generating a speech message by synthesizing speech corresponding to a text message transmitted and received among plural communication terminals, and the apparatus has a speech synthesis data storage device for storing, after categorizing into emotion classes, data for speech synthesis in association with a user identifier uniquely identifying respective users of the plural communication terminals; an emotion determiner for, upon receiving a text message transmitted from a first communication terminal of the plural communication terminals, extracting emotion information for each determination unit of the received text message, the emotion information being extracted from text in the determination unit, and for determining an emotion class based on the extracted emotion information; and a speech data synthesizer for reading, from the speech synthesis data storage device, data for speech synthesis corresponding to the emotion class determined by the emotion determiner, from among data pieces for speech synthesis that are in association with a user identifier indicating a user of the first communication terminal, and for synthesizing speech data with emotional expression corresponding to the text of the determination unit by using the read data for speech synthesis.

The media process server apparatus of the present invention stores data for speech synthesis categorized by user and by emotion class, and synthesizes speech data using data for speech synthesis of a user who is a transmitter of a text message, depending on a determination result of an emotion class for the text message. Therefore, it becomes possible to generate an emotionally expressive speech message by using the transmitter's own voice. Furthermore, because a storage device for storing data for speech synthesis is provided at the media process server apparatus, a greater amount of data for speech synthesis can be registered in comparison with a case in which the storage device is provided at a terminal apparatus such as a communication terminal. Therefore, because the number of users for whom data for speech synthesis is registered and the number of data pieces for speech synthesis which can be registered per user are increased, it becomes possible to synthesize speech messages of high-quality and emotional expressiveness. There is no need to register data for speech synthesis in a terminal apparatus, although this was done conventionally, and the memory capacity of the terminal apparatus is no longer burdened. Furthermore, because a function of determining the emotion of a text message and a function of synthesizing speech are no longer necessary, the processing load on the terminal apparatus is reduced.

According to a preferred embodiment of the present invention, the emotion determiner, in a case of extracting an emotion symbol as the emotion information, may determine an emotion class based on the emotion symbol, the emotion symbol expressing emotion by a combination of plural characters. The emotion symbol is, for example, a text emoticon, and is input by a user of a communication terminal who is a transmitter of a message. In other words, the emotion symbol is for an emotion specified by a user. Therefore, it becomes possible to obtain a determination result that reflects the emotion of a transmitter of a message more precisely, by extracting an emotion symbol as emotion information and determining an emotion class based on the emotion symbol.

According to another embodiment of the present invention, the emotion determiner, in a case in which an image to be inserted into text is attached to the received text message, may extract the emotion information from the image to be inserted into the text in addition to the text in the determination unit, and, when an emotion image is extracted as the emotion information, the emotion image expressing emotion by a graphic, may determine an emotion class based on the emotion image. The emotion image is, for example, a graphic emoticon image, and is input by selection by a user of a communication terminal who is a transmitter of a message. In other words, the emotion image is for an emotion specified by a user. Therefore, it becomes possible to obtain a determination result that reflects the emotion of a transmitter of a message more precisely, by extracting an emotion image as emotion information and determining an emotion class based on the emotion image.

Preferably, the emotion determiner, in a case in which there are plural pieces of emotion information extracted from the determination unit, may determine an emotion class for each of the plural pieces of emotion information, and may select, as a determination result, an emotion class that has the greatest appearance number from among the determined emotion classes. According to this embodiment, emotion that appears most dominantly in a determination unit can be selected.

Alternatively, the emotion determiner, in a case in which there are plural pieces of emotion information extracted from the determination unit, may determine an emotion class based on emotion information that appears at a position that is the closest to an end point of the determination unit. According to this embodiment, an emotion that is closer to the transmission time point can be selected, from among emotions of the transmitter in a message.

In still another preferred embodiment of the present invention, the speech synthesis data storage device may additionally store a parameter for setting, for each emotion class, the characteristics of a speech pattern for each user of the plural communication terminals, and the speech data synthesizer may adjust the synthesized speech data based on the parameter. In the present embodiment, because speech data is adjusted by using a parameter depending on a type of emotion stored for each user, speech data that matches the characteristics of the speech pattern of a user are generated. Therefore, it is possible to generate a speech message that reflects the individual characteristics of voice of a user who is a transmitter.

Preferably, the parameter may be at least one of the average of volume, the average of tempo, the average of prosody, and the average of frequencies of voice in data for speech synthesis stored for each of the users and categorized into the emotions. In this case, speech data is adjusted depending on the volume, speech speed (tempo), prosody (intonation, rhythm, and stress), and frequencies (voice pitch) of each user's voice. Therefore, it becomes possible to reproduce a speech message that is closer to the tone of the user's own voice.

According to another preferred embodiment of the present invention, the speech data synthesizer may parse the text in the determination unit into plural synthesis units and may execute the synthesis of speech data for each of the synthesis units, and the speech data synthesizer, in a case in which data for speech synthesis corresponding to the emotion determined by the emotion determiner is not included in data for speech synthesis in association with the user identifier indicating the user of the first communication terminal, may select and read, from among the data for speech synthesis in association with the user identifier indicating the user of the first communication terminal, data for speech synthesis for which pronunciation partially agrees with the text of the synthesis unit. According to the present invention, even if the character string of text to be speech-synthesized is not stored in a speech synthesis data storage device as it is, speech synthesis can be performed.

Additionally, the present invention provides a media process method for use in a media process server apparatus for generating a speech message by synthesizing speech corresponding to a text message transmitted and received among plural communication terminals, with the media process server apparatus having a speech synthesis data storage device for storing, after categorizing into emotion classes, data for speech synthesis in association with a user identifier uniquely identifying respective users of the plural communication terminals, the method having a determination step of upon receiving a text message transmitted from a first communication terminal of the plural communication terminals, extracting emotion information for each determination unit of the received text message, the emotion information being extracted from text in the determination unit, and of determining an emotion class based on the extracted emotion information; and a synthesis step of reading, from the speech synthesis data storage device, data for speech synthesis corresponding to the emotion class determined in the determination step, from among data pieces for speech synthesis that are in association with a user identifier indicating a user of the first communication terminal, and of synthesizing speech data corresponding to the text of the determination unit by using the read data for speech synthesis. According to the present invention, the same effects as in the above media process server apparatus can be attained.

### EFFECTS OF THE INVENTION

According to the present invention, it is possible to provide a media process server apparatus capable of synthesizing, from text data, a speech message which is of high quality and for which emotional expressions are rich, and to provide a media process method therefor.

### BRIEF DESCRIPTION OF THE DRAWINGS

FIG. 1 is a simplified configuration diagram showing a system for speech synthesis message with emotional expression, the system including a media process server apparatus, according to an embodiment of the present invention.

FIG. 2 is a functional configuration diagram of a communication terminal according to the embodiment of the present invention.

FIG. 3 is a functional configuration diagram of a media process server apparatus according to the embodiment of the present invention.

FIG. 4 is a diagram for describing data managed at a speech synthesis data storage device according to the embodiment of the present invention.

FIG. 5 is a sequence chart for describing a procedure of a media process method according to the embodiment of the present invention.

### BEST MODE FOR CARRYING OUT THE INVENTION

In the following, a detailed description of an embodiment of the present invention will be given with reference to the drawings. In describing the drawings, the same reference numerals are assigned to the same elements, and description thereof will be omitted.

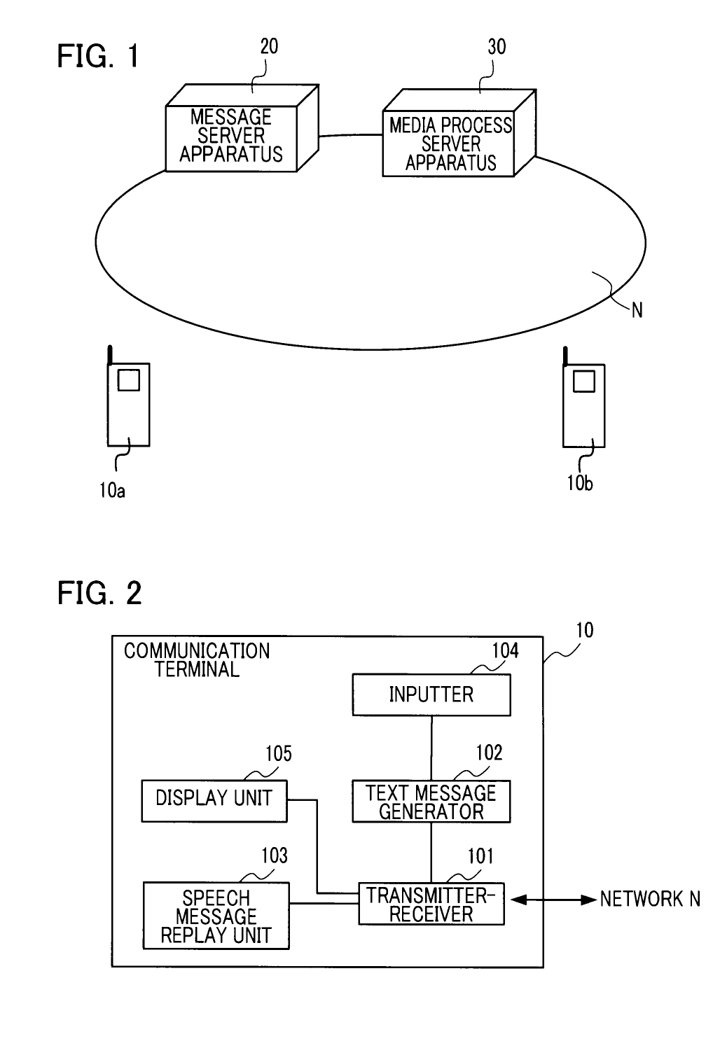

FIG. 1 shows a speech synthesis message system with emotional expression (hereinafter referred to simply as “speech synthesis message system”), the system including a media process server apparatus according to the present embodiment. The speech synthesis message system has plural communication terminals 10 (10a,10b), a message server apparatus 20 for enabling transmission and reception of text messages among communication terminals, a media process server apparatus 30 for storing and processing media information for communication terminals, and a network N connecting the apparatuses. For the sake of simplicity of description, FIG. 1 shows only two communication terminals 10, but in reality, the speech synthesis message system includes a large number of communication terminals.

Network N is a connected point for communication terminal 10, provides a communication service to communication terminal 10, and is, for example, a mobile communication network.

Communication terminal 10 is connected to network N wirelessly or by wire via a relay device (not shown), and is capable of performing communication with another communication terminal connected to network N via a relay device. Although not shown, communication terminal 10 is configured as a computer having hardware such as a CPU (Central Processing Unit), a RAM (Random Access Memory) and a ROM (Read Only Memory) as primary storage devices, a communication module for performing communication, and an auxiliary storage device such as a hard disk. These components work in cooperation with one another, whereby the functions of communication terminal 10 (described later) will be implemented.

FIG. 2 is a functional configuration diagram of communication terminal 10. As shown in FIG. 2, communication terminal 10 has a transmitter-receiver 101, a text message generator 102, a speech message replay unit 103, an inputter 104, and a display unit 105.

Transmitter-receiver 101, upon receiving a text message from text message generator 102, transmits the text message via network N to message server apparatus 20. The text message is, for example, electronic mail, chatting or IM (Instant Messaging). Transmitter-receiver 101, upon receiving from message server apparatus 20 via network N a speech message speech-synthesized at media process server apparatus 30, transfers the speech message to speech message replay unit 103. Transmitter-receiver 101, when it receives a text message, transfers this to display unit 105.

Inputter 104 is a touch panel and a keyboard, and transmits input characters to text message generator 102. Inputter 104, when graphic emoticon images to be inserted in text are input by selection, transmits the input graphic emoticon image to text message generator 102. In selecting a graphic emoticon image, a graphic emoticon dictionary is displayed on display unit 105, with the dictionary stored in a memory (not shown) of this communication terminal 10, and a user of communication terminal 10, by operating inputter 104, can select a desired image from among displayed graphic emoticon images. Such a graphic emoticon dictionary includes, for example, a graphic emoticon dictionary uniquely provided by a communication carrier of network N. “Graphic emoticon images” include an emotion image in which emotion is expressed by a graphic and a non-emotion image in which an event or an object is expressed by a graphic. Emotion images include a facial expression emotion image in which emotion is expressed by changes in facial expressions and a nonfacial expression emotion image, such as a bomb image showing “anger” or a heart image showing “joy” and “affection,” from which emotion can be inferred from the graphics themselves. Non-emotion images include an image of the sun or an umbrella indicating the weather, and an image of a ball or a racket indicating types of sports.

Input characters can include text emoticons or face marks (emotion symbols) representing emotion by a combination of characters (character string). Text emoticons represent emotion by a character string which is a combination of punctuation characters such as commas, colons, and hyphens, symbols such as asterisks and “@” (“at signs”), some letters of the alphabet (“m” and “T”), and the like. A typical text emoticon is “:)” (the colon dots are the eyes and the parenthesis is the mouth) showing a happy face, “>:(” showing an angry face, and a “T T” showing a crying face. In a similar way as graphic emoticons, a text emoticon dictionary has been stored in a memory (not shown) of this communication terminal 10, and a user of communication terminal 10 can select a desired text emoticon, by operating inputter 104, from among text emoticons displayed on display unit 105.

Text message generator 102 generates a text message from characters and text emoticons input by inputter 104 for transfer to transmitter-receiver 101. When a graphic emoticon image to be inputted into text is input by inputter 104 and transmitted to this text message generator 102, the text message generator generates a text message including this graphic emoticon image as an attached image, for transfer to transmitter-receiver 101. In this case, text message generator 102 generates insert position information indicating an insert position of a graphic emoticon image, and transfers, to transmitter-receiver 101, the insert position information by attaching it to a text message. In a case in which plural graphic emoticon images are attached, this insert position information is generated for each graphic emoticon image. Text message generator 102 is software for electronic mails, chatting, or IM, installed in communication terminal 10. However, it is not limited to software but may be configured by hardware.

Speech message replay unit 103, upon receiving a speech message from transmitter-receiver 101, replays the speech message. Speech message replay unit 103 is a speech encoder and a speaker. Display unit 105, upon receiving a text message from transmitter-receiver 101, displays the text message. In a case in which a graphic emoticon image is attached to a text message, the text message is displayed, with the graphic emoticon image inserted at a position specified by insert position information. Display unit 105 is, for example, an LCD (Liquid Crystal Display), and is capable of displaying various types of information as well as the received text message.

Communication terminal 10 is typically a mobile communication terminal, but it is not limited thereto. For example, a personal computer capable of performing voice communication or an SIP (Session Initiation Protocol) telephone can be used. In the present embodiment, description will be given, assuming that communication terminal 10 is a mobile communication terminal. In this case, network N is a mobile communication network, and the above relay device is a base station.

Message server apparatus 20 is a computer apparatus mounted with an application server computer program for electronic mail, chatting, IM, and other programs. Message server apparatus 20, upon receiving a text message from communication terminal 10, transfers the received text message to media process server apparatus 30 if transmitter communication terminal 10 subscribes to a speech synthesis service. The speech synthesis service is a service for executing speech synthesis on a text message transmitted by electronic mail, chatting, and IM, and for delivering the text message as a speech message to the destination. A speech message is generated and delivered when a message is transmitted only from or to communication terminal 10 to which this service is subscribed by contract.

Media process server apparatus 30 is connected to network N, and is connected to communication terminal 10 via this network N. Although not shown in the figure, media process server apparatus 30 is configured as a computer having hardware such as a CPU, a RAM and a ROM being primary storage devices, a communication module for performing communication, and an auxiliary storage device such as a hard disk. These components work in cooperation with one another, whereby the functions of media process server apparatus 30 (described later) will be implemented.

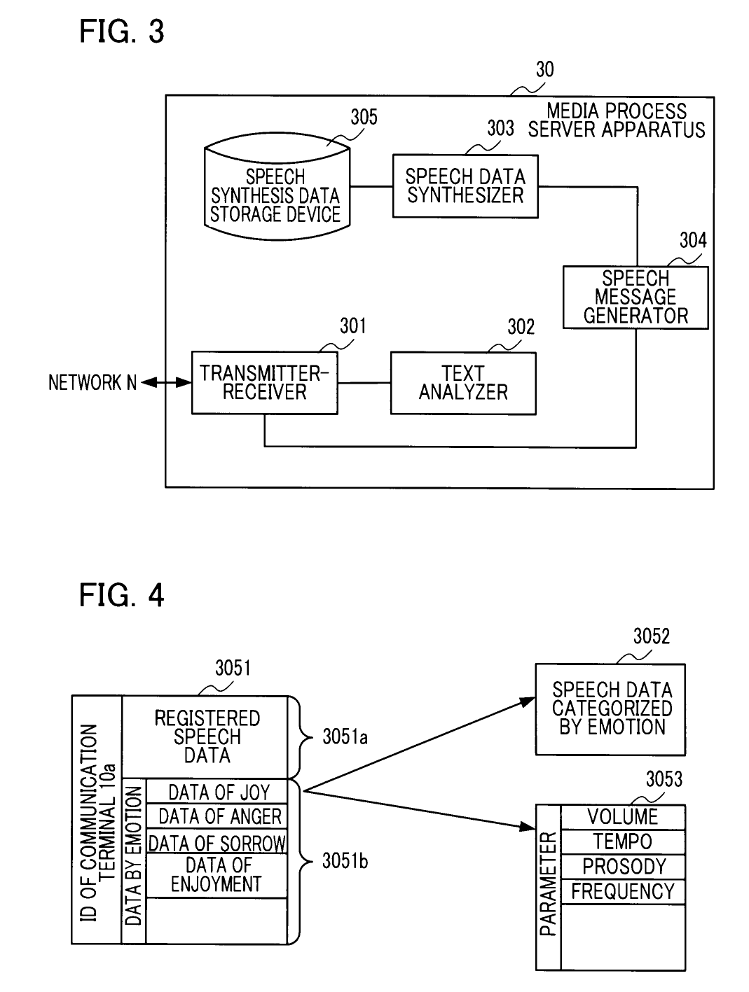

As shown in FIG. 3, media process server apparatus 30 has a transmitter-receiver 301, a text analyzer 302, a speech data synthesizer 303, a speech message generator 304, and a speech synthesis data storage device 305.

Transmitter-receiver 301, upon receiving a text message from message server apparatus 20, transfers the text message to text analyzer 302. Transmitter-receiver 301, upon receiving a speech-synthesized message from speech message generator 304, transfers the message to message server apparatus 20.

Upon receiving a text message from transmitter-receiver 301, text analyzer 302 extracts, from a character or a character string and an attached image, emotion information indicating the emotion of the contents of the text, to determine, by inference, an emotion class based on the extracted emotion information. The text analyzer then outputs, to speech data synthesizer 303, information indicating the determined emotion class together with text data to be speech-synthesized.

Specifically, text analyzer 302, determines emotion from a graphic emoticon image separately attached to electronic mail and the like and text emoticons (emotion symbol). Text analyzer 302 recognizes an emotion class of text also from words expressing emotions such as “delightful”, “sad”, “happy”, and the like.

More specifically, text analyzer 302 determines an emotion class of the text for each determination unit. In the present embodiment, a punctuation (a terminator showing the end of a sentence; “∘” (small circle) in Japanese and a period “.” (dot) in English) or a space in the text for the text message is detected to parse the text, to use each parsed text as a determination unit.

Subsequently, text analyzer 302 determines emotion by extracting emotion information indicating emotion expressing a determination unit from a graphic emoticon image, a text emoticon, and a word appearing in the determination unit. Specifically, text analyzer 302 extracts, as the above emotion information, an emotion image of graphic emoticon images, every text emoticon, and every word indicating emotion. For this reason, there are stored in a memory (not shown) of media process server apparatus 30 a graphic emoticon dictionary, a text emoticon dictionary, and a dictionary of words indicating emotion. There are stored, in each of the text emoticon dictionary and graphic emoticon dictionary, the character strings of words corresponding to each of text emoticons and graphic emoticons.

Because many different kinds of emotions can be expressed by text emoticons and graphic emoticon images, it is often the case that emotion can be expressed more easily and precisely by text emoticons and graphic emoticon images than by expressing emotions in sentences. Therefore, a transmitter of a text message of electronic mail (especially electronic mail of mobile phones), chatting, IM, and the like, in particular, tends to express the emotion of the transmitter, counting on text emoticons and graphic emoticon images. Because the present embodiment is configured so that text emoticons and graphic emoticon images are used in determining emotion of a text message such as electronic mails, chatting, IM, and the like, emotion is determined by emotion specified by a transmitter him/herself of the message. Therefore, in comparison with a case in which emotion is determined only by using words contained in sentences, it is possible to obtain a determination result that more precisely reflects the emotion of the transmitter of the message.

In a case in which plural pieces of emotion information appear in one determination unit, text analyzer 302 may determine an emotion class for each emotion information, and count the number of appearances of each of the determined emotion classes, to select emotion that has the greatest appearance number, or may select emotion of a graphic emoticon, a text emoticon, or a word that appears at a position that is the closest to the end or end point of the determination unit.

With regard to a method for separating the text data into determination units, the point of separation for determination units should be appropriately changed and set depending on the characteristics of a language in which the text is written. Furthermore, words to be extracted as emotion information should be appropriately selected depending on the language.

As described in the foregoing, text analyzer 302 serves as an emotion determiner for, for each determination unit of the received text message, extracting emotion information from text in the determination unit and determining an emotion class based on the extracted emotion information.

Furthermore, text analyzer 302 executes morphological analysis on text parsed into determination units, and parses each determination unit into smaller synthesis units. A synthesis unit is a standard unit in performing a speech synthesis process (speech synthesis processing or text-to-speech processing). Text analyzer 302, after dividing text data showing the text in a determination unit into synthesis units, transmits, to speech data synthesizer 303, the text data together with information indicating a result of emotion determination for the entire determination unit. In a case in which a text emoticon is included in text data of a determination unit, the text analyzer replaces a character string making up this text emoticon with a character string of a corresponding word, for subsequent transmission to speech data synthesizer 303 as one synthesis unit. Similarly, in a case in which a graphic emoticon image is included, the text analyzer replaces this graphic emoticon image with a character string of a corresponding word, for subsequent transmission as one synthesis unit to speech data synthesizer 303. The replacement of text emoticons and graphic emoticons are executed by referring to a text emoticon dictionary and a graphic emoticon dictionary stored in a memory.

There may be a case in which a text message includes a graphic emoticon image or a text emoticon as an essential configuration of a sentence (for example, “It is [a graphic emoticon representing “rainy”] today.”) and a case in which at least one of a graphic emoticon or a text emoticon is included right after a character string of a word, the graphic emoticon and the text emoticon having the same meaning as the word (for example, “It is rainy [a graphic emoticon representing “rainy”] today”). In the latter case, if the above replacement is executed, a character string corresponding to a graphic emoticon image of “rainy” is inserted after a character string of “rainy”. Therefore, in a case in which the character strings of two consecutive synthesis units are the same or almost the same, one of them may be deleted before transmitting the text data to speech data synthesizer 303. Alternatively, the text analyzer may search whether a determination unit including a graphic emoticon image or a text emoticon also includes a word having the same meaning as the graphic emoticon image or the text emoticon, and if it does, the graphic emoticon or the text emoticon may be simply deleted without replacing it with a character string.

Speech data synthesizer 303 receives, from text analyzer 302, text data to be speech-synthesized and information showing an emotion class of a determination unit thereof. Speech data synthesizer 303, for each synthesis unit, based on the received text data and emotion information, retrieves data for speech synthesis corresponding to the emotion class from data for communication terminal 10a in speech synthesis data storage device 305, and, if speech that corresponds to the text data as it is has been registered, reads and uses the data for speech synthesis.

In a case in which speech that corresponds as it is to the text data of a synthesis unit has not been registered, speech data synthesizer 303 reads data for speech synthesis of a relatively similar word, and uses this data for synthesizing speech data. When speech synthesis of text data for every synthesis unit in a determination unit is completed, speech data synthesizer 303 combines speech data pieces for synthesis units, to generate speech data for the entire determination unit.

The relatively similar word is a word for which the pronunciation is partially identical, and, for example, is “tanoshi-i (enjoyable)” for “tanoshi-katta (enjoyed)” and “tanoshi-mu (enjoy)”. Specifically, if data for speech synthesis corresponding to a word, “tanoshi-i” is registered but data for speech synthesis corresponding to a word for which the ending in Japanese is changed such as “tanoshi-katta” and “tanoshi-mu” is not registered, the registered data for speech synthesis for “tanoshi”, the stem portion of “tanoshi-katta” and “tanoshi-mu”, is extracted, and “-katta” for “tanoshi-katta” or “-mu” for “tanoshi-mu” is extracted from another word in the same emotion class, thereby synthesizing “tanoshi-katta” or “tanoshi-mu”. Likewise, in a case in which a corresponding character string is not registered for graphic emoticons and text emoticons, speech data can be synthesized by extracting a relatively similar word.

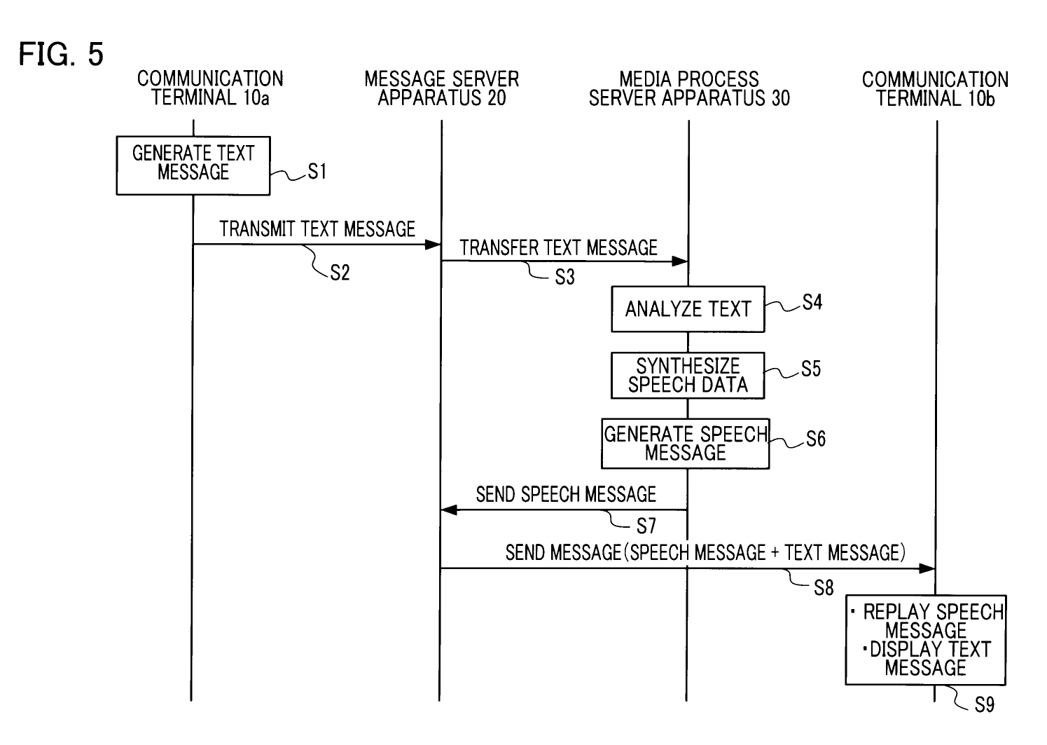

FIG. 4 is data managed at speech synthesis data storage device 305. The data is managed for each user in association with a user identifier such as a communication terminal ID, a mail address, a chat ID, or an IM ID. In an example of FIG. 4, a communication terminal ID is used as a user identifier, and data for communication terminal 10a 3051 is shown as an example. Data for communication terminal 10a 3051 is speech data of a user's own voice for communication terminal 10a, and is managed, as shown, separately in speech data 3051a in which speech data is registered without being categorized into emotions and data portion by emotion 3051b. Data portion by emotion 3051b has speech data 3052 categorized into emotions and parameter 3053 for each emotion.

Speech data 3051a in which speech data is registered without being categorized into emotions is speech data registered after separating the registered speech data into predetermined section units (for example, bunsetsu, or segments) but not being categorized by emotion. Speech data 3051a registered in a data portion for each emotion is speech data registered for each emotion class after separating the registered speech data into the predetermined section units. In a case in which a language that is an object of the speech synthesis service is a language other than Japanese, speech data should be registered by using a section unit suited for the language instead of bunsetsu, or a segment.

In registering speech data, for communication terminal 10 subscribing to the speech synthesis service, (i) a method of recording at media process server apparatus 30 by a user speaking to communication terminal 10 in a state in which communication terminal 10 and media process server 30 are connected via network N, (ii) a method of duplicating the content of voice communication between communication terminals 10, for storage at media process server 30, and (iii) a method of storing at communication terminal 10 a word input in voice by a user during a word speech recognition game, and transferring via a network to media process server 30 the stored word after the game is completed, for storage therein, and the like, can be conceived.

In categorizing speech data, (i) a method of providing a memory area for each user and for each emotion at media process server apparatus 30 and registering, in accordance with an instruction for an emotion class received from communication terminal 10, voice data spoken on or after the instruction for the class in a memory area of a corresponding emotion and (ii) a method of preparing in advance a dictionary of text information for use in the categorization in accordance with emotions, executing speech recognition at a server, and automatically categorizing speech data at the server when a word that falls in each emotion is found can be conceived.

Thus, in the present embodiment, because data for speech synthesis is stored at media process server apparatus 30, the number of users for whom data for speech synthesis can be stored and the number of registered pieces of data for speech synthesis per user can be increased in comparison with a case in which data for speech synthesis is stored at communication terminal 10 having limited memory capacity. Therefore, variations of emotional expressions to be synthesized can be increased, and the synthesis can be performed with higher accuracy. Accordingly, speech synthesis data of higher quality can be generated.

Furthermore, because it is during voice communication that a conventional terminal apparatus learns and registers voice characteristic data (data for speech synthesis) of a person at the other end, a message that can be speech-synthesized using the voice of the transmitter of a piece of electronic mail is limited to a case in which the user of the terminal apparatus has spoken on the phone by voice with the transmitter. However, according to the present embodiment, even if communication terminal 10 (for example, communication terminal 10b), a receiver of a text message, has not actually performed communication by voice with communication terminal 10 (for example, communication terminal 10a) which has transmitted the message, a speech message synthesized using the voice of the user of communication terminal 10a can be received if data for speech synthesis for a user of communication terminal 10a is stored at media process server apparatus 30.

Furthermore, data portion 3051b has speech data 3052 categorized by emotion and the average parameter 3053 of speech data registered by emotion. Speech data 3052 by emotion is data for which speech data that is registered without being categorized by emotion is categorized by emotion and stored.

According to the present embodiment, a piece of data is registered in duplication, being categorized or uncategorized by emotion. Therefore, the actual speech data may be registered in an area for registered speech data 3051a, whereas a data area by emotion 3051b may store text information of registered speech data and a pointer (address, number) of an area of speech data actually registered. More specifically, assuming that speech data “enjoyable” is stored in Address No. 100 of an area for registered speech data 3051a, it may be configured so that data area by emotion 3051b stores text information “enjoyable” in an area for “data of ‘enjoyment’” and also stores Address No. 100 as the storage location of the actual speech data.

As parameter 3053, the voice volume, the tempo of voice, a prosody or rhythm, the frequency of voice, and the like are set as parameters for expressing a speech pattern (way of speaking) corresponding to each emotion for the user of communication terminal 10a.

Speech data synthesizer 303, when the speech synthesis of a determination unit is completed, adjusts (processes) the synthesized speech data based on parameter 3053 of a corresponding emotion stored in speech synthesis data storage device 305. The speech data synthesizer matches the finally synthesized speech data of a determination unit again with the parameters for each emotion, and checks whether speech data is in accordance with the registered parameters as a whole.

When the above check is completed, speech data synthesizer 303 transmits synthesized speech data to speech message generator 304. Hereinafter, the speech data synthesizer repeats the above operation for text data of each determination unit received from text analyzer 302.

The parameters for each emotion are set for each emotion class as a speech pattern of each user of mobile communication terminal 10, and are, as shown in parameter 3053 of FIG. 4, the voice volume, tempo, prosody, frequency, and the like. Adjusting synthesized speech by referring to parameters of each emotion means to adjust the prosody and the tempo of the voice, for example, in accordance with the average parameter of the emotion. In synthesizing speech, because a word is selected from a corresponding emotion for speech synthesis, the juncture of synthesized speech and another speech may sound uncomfortable. Therefore, by adjusting the prosody and the tempo of voice, for example, in accordance with the average parameter of the emotion, the uncomfortable sound of junctions between the synthesized speech and another speech can be reduced. More specifically, the averages of the volume, tempo, prosody, frequency, or the like of speech data are calculated from speech data registered for each emotion, and calculated averages are stored as the average parameter (reference numeral 3053 in FIG. 4) representing each emotion. Speech data synthesizer 303 compares these average parameters and each value of the synthesized speech data, to adjust the synthesized speech so that each value thereof comes closer to the average parameter if a wide discrepancy is found. From among the above parameters, the prosody is used for adjusting the rhythm, stress, or intonation of the voice of an entire set of speech data corresponding to the text of a determination unit.

Speech message generator 304, upon receiving synthesized speech data for every determination unit from speech data synthesizer 303, joins the received pieces of speech data, to generate a speech message corresponding to a text message. The generated speech message is transferred to message server apparatus 20 by transmitter-receiver 301. Joining pieces of speech data means, for example, in a case in which a sentence in a text message is configured by interleaving two graphic emoticons such as “xxxx [Graphic emoticon 1] yyyy [Graphic emoticon 2]”, to speech-synthesize a phrase before Graphic emoticon 1 by emotion corresponding to Graphic emoticon 1 and to speech-synthesize a phrase before Graphic emoticon 2 by emotion corresponding to Graphic emoticon 2. The pieces of speech data synthesized respectively by each emotion are finally output as a speech message of one sentence. In this case, “xxxx [Graphic emoticon 1]” and “yyyy [Graphic emoticon 2]” each correspond to the above determination unit.

Data stored in speech synthesis data storage device 305 is used by speech data synthesizer 303 to generate speech synthesis data. That is, speech synthesis data storage device 305 supplies data for speech synthesis and parameters to speech data synthesizer 303.

FIG. 5 is next referred to, to describe a process in the speech synthesis message system according to the present embodiment. This process shows, during a process in which a text message from communication terminal 10a (first communication terminal) to communication terminal 10b (second communication terminal) is transmitted via message server apparatus 20, a process of media process server apparatus 30 synthesizing a speech message with emotional expression corresponding to the text message, for transmission as a speech message to communication terminal 10b.

Communication terminal 10a generates a text message for communication terminal 10b (S1). An example of the text message includes an IM, an electronic mail, or chatting.

Communication terminal 10a transmits the text message generated in Step S1 to message server apparatus 20 (S2).

Message server apparatus 20, upon receiving the message from communication terminal 10a, transfers the message to the media process server apparatus (S3). Message server apparatus 20, upon receiving the message, first determines whether communication terminal 10a or communication terminal 10b subscribes to the speech synthesis service. Specifically, message server apparatus 20 once checks contract information, and, in a case in which a message is from communication terminal 10 or to communication terminal 10 subscribing to the speech synthesis service, transfers the message to media process server apparatus 30, and otherwise transmits the message as it is as a normal text message to communication terminal 10b. In a case in which a text message is not transferred to media process server apparatus 30, media process server apparatus 30 does not take part in the processing of the text message, and the text message is processed in the same way as transmitting or receiving normal electronic mail, chatting, or IM.

Media process server apparatus 30, upon receiving the text message from message server apparatus 20, determines the emotion in the message (S4).

Media process server apparatus 30 speech-synthesizes the received text message in accordance with the emotion determined in Step S4 (S5).

Media process server apparatus 30, upon generating speech-synthesized speech data, generates a speech message corresponding to the text message transferred from message server apparatus 20 (S6).

Media process server apparatus 30, upon generating the speech message, sends the speech message back to message server apparatus 20 (S7). In this case, media process server apparatus 30 transmits, to message server apparatus 20, a synthesized speech message together with the text message transferred from message server apparatus 20. Specifically, the speech message is transmitted as the attached file of the text message.

Message server apparatus 20, upon receiving the speech message from media process server apparatus 30, transmits the speech message together with the text message to communication terminal 10b (S8).

Communication terminal 10b, upon receiving the speech message from message server apparatus 20, replays the speech (S9). The received text message is displayed by software for electronic mail. In this case, the text message may be displayed only when there is an instruction from a user.

### Modification

The above embodiment shows an example in which speech data is stored in speech synthesis data storage device 305, categorized by emotion and separated into bunsetsu or segments or the like, but the present invention is not limited thereto. For example, it may be configured so that speech data is stored by emotion after dividing the data by phoneme. In this case, it may be configured so that speech data synthesizer 303 receives, from text analyzer 302, text data to be speech-synthesized and information indicating emotion corresponding to the text thereof, reads a phoneme that is data for speech synthesis corresponding to the emotion from database for speech synthesis 305, uses the phoneme to synthesize speech.

In the above embodiment, text is divided into determination units by punctuations and spaces, but it is not limited thereto. For example, a graphic emoticon and text emoticon are often inserted at the end of a sentence. Therefore, in a case in which a graphic emoticon or a text emoticon in included, the graphic emoticon or text emoticon may be considered as a delimiter for the sentence, and a determination unit may be parsed accordingly. Also, because a graphic emoticon or a text emoticon is sometimes inserted right after a word or in place of a word, text analyzer 302 may determine, as one determination unit, a portion delimited by positions at which punctuations appear to the front and to the back of a position at which a graphic emoticon or a text emoticon appears. Alternatively, an entire text message may be regarded as a determination unit.

There may be a case in which no emotion information is extracted from a determination unit. In such a case, for example, a result of emotion determination based on emotion information extracted in the immediately previous or subsequent determination unit may be used to perform speech synthesis of text. Furthermore, in a case in which only one piece of emotion information is extracted from a text message, a result of emotion determination based on the emotion information may be used to speech synthesize the entire text message.

In the above embodiment, no particular limits are put on words to be extracted as emotion information. However, a list of words to be extracted may be prepared in advance, and, in a case in which a word in the list is included in a determination unit, the word may be extracted as emotion information. According to this method, because only limited emotion information is extracted and is used as an object of the determination, emotion determination can be performed more easily in comparison with a method of performing emotion determination on the entire text of a determination unit. Therefore, the process time required for emotion determination can be reduced, and the delivery of a speech message can be performed quickly. Also, media process server apparatus 30 requires less processing load. Furthermore, if it is configured so that words are excluded from items from which emotion information is to be extracted (i.e., only text emoticons and graphic emoticon images are extracted as emotion information), the processing time is further shortened, and the processing load is further reduced.

In the above embodiment, description was given for a case in which a communication terminal ID, a mail address, a chat ID, or an IM ID is used as a user identifier. A single user sometimes has plural communication terminal IDs and mail addresses. For this reason, a user identifier for uniquely identifying a user may be separately provided, so that speech synthesis data is managed in association with this user identifier. In this case, a correspondence table in which a communication terminal ID, a mail address, a chat ID, an IM ID, or the like and a user identifier are associated may be preferably stored additionally.

In the above embodiment, message server apparatus 20 transfers a received text message to media process server apparatus 30 only when a transmitter or a receiver terminal of the text message subscribes to the speech synthesis service. However, all the text messages may be transferred to media process server apparatus 30 regardless of engagement with the service.

### DESCRIPTION OF REFERENCE NUMERALS

10,10a,10b communication terminal
101 transmitter-receiver
102 text message generator
103 speech message replay unit
104 inputter
105 display
20 message server apparatus
30 media process server apparatus
301 transmitter-receiver
302 text analyzer (emotion determiner)
303 speech data synthesizer
304 speech message generator
305 speech synthesis data storage device
N network

1. A media process server apparatus for generating a speech message by synthesizing speech corresponding to a text message transmitted and received among plural communication terminals,
the apparatus comprising:
a speech synthesis data storage device for storing, after categorizing into emotion classes, data for speech synthesis in association with a user identifier uniquely identifying respective users of the plural communication terminals;
an emotion determiner for, upon receiving a text message transmitted from a first communication terminal of the plural communication terminals, extracting emotion information for each determination unit of the received text message, the emotion information being extracted from text in the determination unit, and for determining an emotion class based on the extracted emotion information; and
a speech data synthesizer for reading, from the speech synthesis data storage device, data for speech synthesis corresponding to the emotion class determined by the emotion determiner, from among data pieces for speech synthesis that are in association with a user identifier indicating a user of the first communication terminal, and for synthesizing speech data with emotional expression corresponding to the text of the determination unit by using the read data for speech synthesis.

2. A media process server apparatus according to claim 1,
wherein the emotion determiner, in a case of extracting an emotion symbol as the emotion information, determines an emotion class based on the emotion symbol, the emotion symbol expressing emotion by a combination of plural characters.

3. A media process server apparatus according to claim 1,
wherein the emotion determiner, in a case in which an image to be inserted into text is attached to the received text message, extracts the emotion information from the image to inserted into the text in addition to the text in the determination unit, and, when an emotion image is extracted as the emotion information, the emotion image expressing emotion by a graphic, determines an emotion class based on the emotion image.

4. A media process server apparatus according to claim 1,
wherein the emotion determiner, in a case in which there are plural pieces of emotion information extracted from the determination unit, determines an emotion class for each of the plural pieces of emotion information, and selects, as a determination result, an emotion class that has the greatest appearance number from among the determined emotion classes.

5. A media process server apparatus according to claim 1,
wherein the emotion determiner, in a case in which there are plural pieces of emotion information extracted from the determination unit, determines an emotion class based on emotion information that appears at a position that is the closest to an end point of the determination unit.

6. A media process server apparatus according to claim 1,
wherein the speech synthesis data storage device additionally stores a parameter for setting, for each emotion class, the characteristics of a speech pattern for each user of the plural communication terminals, and
wherein the speech data synthesizer adjusts the synthesized speech data based on the parameter.

7. A media process server apparatus according to claim 6,
wherein the parameter is at least one of the average of volume, the average of tempo, the average of prosody, and the average of frequencies of voice in data for speech synthesis stored for each of the users and categorized into the emotion classes.

8. A media process server apparatus according to claim 1,
wherein the speech data synthesizer separates the text in the determination unit into plural synthesis units and executes the synthesis of speech data for each of the synthesis units,
wherein the speech data synthesizer, in a case in which data for speech synthesis corresponding to the emotion class determined by the emotion determiner is not included in data for speech synthesis in association with the user identifier indicating the user of the first communication terminal, selects and reads, from among the data for speech synthesis in association with the user identifier indicating the user of the first communication terminal, data for speech synthesis for which pronunciation partially agrees with the text of the synthesis unit.

9. A media process method for use in a media process server apparatus for generating a speech message by synthesizing speech corresponding to a text message transmitted and received among plural communication terminals,
wherein the media process server apparatus comprises a speech synthesis data storage device for storing, after categorizing into emotion classes, data for speech synthesis in association with a user identifier uniquely identifying respective users of the plural communication terminals,
the method comprising:
a determination step of, upon receiving a text message transmitted from a first communication terminal of the plural communication terminals, extracting emotion information for each determination unit of the received text message, the emotion information being extracted from text in the determination unit, and of determining an emotion class based on the extracted emotion information; and
a synthesis step of reading, from the speech synthesis data storage device, data for speech synthesis corresponding to the emotion class determined in the determination step, from among data pieces for speech synthesis that are in association with a user identifier indicating a user of the first communication terminal, and of synthesizing speech data corresponding to the text of the determination unit by using the read data for speech synthesis.
